(19) United States
(12) Patent Application Publication
(10) Pub. No.: US 2006/0092344 A1
(43) Pub. Date: May 4, 2006

(54) Illumination unit and liquid crystal display comprising it

(76) Inventors: Toshihiko Ura, Nomi-gun, Ishikawa (JP); Yasushi Sakuda, Nomi-gun, Ishikawa (JP); Yoshinori Yasuda, Ishikawa-gun, Ishikawa (JP)

Correspondence Address: MCDERMOTT WILL & EMERY LLP, 600 13TH STREET, N.W., WASHINGTON, DC, 20005-3096, US

(21) Appl. No.: 10/528,077

(22) PCT Filed: Sep. 19, 2002
(86) PCT No.: PCT/JP02/09594

§ 371 Date: Sep. 7, 2005

(51) Int. Cl. G02F 1/1333; G02F 1/1335

(52) U.S. Cl. 349/58; 349/64

(57) ABSTRACT

In a liquid crystal display device according to the present invention, a contact holding portion (10s) which contacts a light guiding plate (3) is provided on a housing (10), and, at least either of the contact holding portion (10s) of the housing (10) and a portion (3b) of the light guiding plate (3) corresponding to the contact holding portion of the housing has a processed surface SA formed by a process such as texturing for increasing roughness degree thereof. And, lubricating grease is applied to at least either of the contact holding portion (10s) of the housing (10) and the portion (3b) of the light guiding plate (3) corresponding to the contact holding portion of the housing.

### TECHNICAL FIELD

The present invention relates both to a lighting unit and to a liquid crystal display device using the same.

### BACKGROUND ART

Recently, a liquid crystal display device has been widely used as a display device of an information device such as a notebook-type personal computer, a word processor and the like, or as a display device of a video device such as a portable television, a video movie, a car navigation system and the like, by taking advantage of characteristics in which the liquid crystal display device is light and thin, and consumes small electricity. Such liquid crystal display device typically has a structure in which a display element is illuminated from behind by a built-in lighting unit for obtaining a bright display screen.

As a structure of the lighting unit, there is an edge light type in which a light guiding plate is disposed on a rear surface of the display element, and a linear light source such as a fluorescent discharge tube is disposed on an end face of the light guiding plate. The edge light type excels in achieving a thin lighting unit and a light emitting surface thereof with a uniform luminance. Therefore, this is commonly adopted as a backlight type of the liquid crystal display device used in the notebook-type personal computer or the like in order to give priority to thinness of the liquid crystal display device. In the liquid crystal display device used in a portable television, a car navigation system and the like, the edge light type in which the light sources are disposed on both right and left sides of the light guiding plate, or the light source is disposed on one side of the light guiding plate is commonly adopted in order for the thinness and the luminance to be compatible with each other.

FIG. 7 shows a conventional lighting unit UT of the edge light type in which light sources are disposed on both sides of the light guiding plate, and a liquid crystal display device L including the same. The lighting unit UT comprises a flat transparent light guiding plate 3 configured to transmit light to an entire rear surface thereof, light sources 2 disposed on one side surface of the light guiding plate 3, a reflecting sheet 5 for guiding light generated from the light sources 2 to end faces 3a of the light guiding plate 3, a light correction sheet 9 for uniformizing or the like the light emanating from the light guiding plate 3, and housings 10 for holding the light guiding plate 3, reflectors 4, the reflecting sheet 5, and the light correction sheet 9.

The light guiding plate 3 is made of a material having optimal optical characteristics, such as transmissivity and a refractive index or the like required for transmitting light, for example, acrylic. The reflecting sheet 5 serves to return the light emanating from the light guiding plate 3 to the same again, thereby increasing an illumination light emanating from a light emanating surface. White resinous film having high reflectivity is used as the reflecting sheet 5.

The reflector 4 is configured to allow the light from the light sources 2 to efficiently enter the incident end face 3a of the light guiding plate 3, and folded in U-shape in cross-section so as to enclose the light sources 2. The reflector 4 may be integral with the reflecting sheet 5 by folding a portion of the reflecting sheet 5 in substantially U-shape around the vicinity of the light sources 2 (the reflector portion).

The housing 10 is disposed in the vicinity of the reflector 4 so as to enclose side and upper surfaces thereof. The housing 10 serves to hold a liquid crystal display panel 1, the light sources 2, and the light guiding plate 3 as well as the reflector. The housing 10 is made of polycarbonate resin, for example, and a rear surface thereof is covered with a rear cover RC.

The light correction sheet 9 is disposed on an illuminating surface side of the light guiding plate 1. As the light correction sheet 9, there is a diffusion sheet, a prism sheet, and the like. By providing a plurality of sheets of various specifications as necessary, the light illuminated from the light guiding plate is diffused, and thereby uniform and highly luminous illumination light is obtained. The light correction sheet 9 is stored within a space formed by the light guiding plate 3, a contact holding portion 10s of the housing 10, and a sheet holding portion 10b, a lower surface of which is cut, with a predetermined clearance kept.

The liquid crystal display device L is structured such that a liquid crystal display panel 1 is mounted on a front (above in the drawing) of the lighting unit UT structured as described above. And, the light emitted from the light source 2 is guided to the light guiding plate 3 directly or by being collected by means of the reflector 4, and uniformly transmitted to an entire rear surface of the liquid crystal display panel 1. Thereby, characters and images reflected in a display surface la of the liquid crystal display panel 1 are visually recognized.

In the above-described conventional structure, however, there has been a problem that any of the components of the lighting unit UT and the liquid crystal display device L disagreeably cracks. The disagreeable crack is generated not only while using the lighting unit UT and the liquid crystal display device L, but also after using the same, but it is not clear where the crack is generated.

### DISCLOSURE OF THE INVENTION

The present invention is aimed at solving the above-described problem. A cause of occurrence of a disagreeable crack in a lighting unit and a liquid crystal display device is examined. And, an object of the present invention is to provide a lighting unit and a liquid crystal display device using the same capable of inhibiting occurrence of the crack.

The inventors or the like of the present invention clarified a mechanism of occurrence of the disagreeable crack as described below, by an experiment in which a light source of the lighting unit and the liquid crystal display device was turned on and off repeatedly. When the liquid crystal display device is turned off and left under an environment of a constant temperature for a long time, since surfaces of a light guiding plate and of a housing at a contact portion are very smooth and pressed against each other by a predetermined pressure, the light guiding plate and the housing weakly adhere to each other by van der Waals forces or the like at the contact portion thereof to form adhesive surfaces. However, if the liquid crystal display device is operated in this state, a vicinity of the light source is heated by heat generated from the light source, so that the light guiding plate and the housing start to thermally expand according to respective thermal expansion coefficients different from each other. And, when a difference in an amount of thermal expansion in a direction substantially parallel to the adhesive surfaces between the light guiding plate and the housing increases with an elapse of time to a state in which the adhesive state of the adhesive surfaces is not maintained, the adhesive surfaces are separated and disagreeable crack occurs consequently. The fact that separating noise is also caused by thermal contraction by turning off the light source helps examine the cause thereof.

And, in order to achieve the above-described object, a lighting unit according to the present invention comprises a light guiding plate for guiding light entering from an end face thereof along a principal surface thereof, a light source disposed along the end face of the light guiding plate, and a reflector configured to enclose the light source to reflect the light emitted from the light source toward the end face of the light guiding plate, a housing disposed to enclose at least the reflector and configured to hold the light guiding plate, wherein at least one contact surface of a predetermined region at which the housing and the light guiding plate contact each other is roughened.

As used herein, the wording “contact” means that the housing and the light guiding plate directly contact each other, and that the housing and the light guiding plate contact each other with another member or the like interposed therebetween.

In such a configuration, since at least one contact surface of the predetermined region at which the housing and the light guiding plate contact each other is formed to increase roughness degree, the light guiding plate and the housing do not adhere to each other at the contact portion, and therefore, the separating noise generated between the light guiding plate and the housing is inhibited even when the light guiding plate and the housing thermally expand by heat generated from the light source and thermally contract by turning off the light source. So, cushioning is exercised between the light guiding plate and the housing.

In this case, lubricant may be applied to the predetermined region at which the housing and the light guiding plate are opposed to each other.

In such a configuration, since the lubricant is applied to the predetermined region at which the housing and the light guiding plate are opposed to each other, the light guiding plate and the housing do not adhere to each other at the contact portion. Therefore, the separating noise generated between the light guiding plate and the housing is inhibited even when the light guiding plate and the housing thermally expand by heat generated from the light guiding plate and thermally contract by turning off the light source.

In this case, a sliding member may be disposed on the predetermined region at which the housing and the light guiding plate are opposed to each other. The sliding member having a sliding characteristic may be made of policarbonate resin or the like, synthetic resin such as transparent acrylic plate, polyacetal, fluorine-based material, and the like. This may also be formed by a light correction sheet for uniformizing and amplifying the light emanating from the light guiding plate and entering the liquid crystal display device. The sliding member having the sliding characteristic is not always required to be transparent, but the sliding member disposed along the front surface of the light guiding plate, such as the light correction sheet, is required to be transparent so as not to adversely affect the optical characteristics of the light guiding plate.

In such a configuration, since the sliding member is disposed on the predetermined region at which the housing and the light guiding plate are opposed to each other, the light guiding plate and the housing do not adhere to each other at the contact portion, and therefore, the separating noise generated between the light guiding plate and the housing is inhibited even when the light guiding plate and the housing thermally expand by heat generated from the light source and thermally contract by turning off the light source. So cushioning is exercised between the light guiding plate and the housing. In addition, since a sliding member having the sliding characteristic, which is different from the housing and the light guiding plate is interposed therebetween, it is not required to provide contact holding portion by processing the conventional housing.

A lighting unit according to the present invention comprises a light guiding plate for guiding light entering from an end face thereof along a principal surface thereof, a light source disposed along the end face of the light guiding plate, a reflector configured to enclose the light source to reflect the light emitted from the light source toward the end face of the light guiding plate, and a housing disposed to enclose at least the reflector and configured to hold the light guiding plate, wherein a transparent sheet is disposed on the principal surface of the light guiding plate, and the transparent sheet is disposed on a predetermined region at which the housing and the light guiding plate are opposed to each other.

In such a configuration, since the transparent sheet is superposed on the principal surface of the light guiding plate, and an end portion thereof is interposed between the housing and the light guiding plate, the light guiding plate and the housing do not adhere to each other at the contact portion, and therefore, the separating noise generated between the light guiding plate and the housing is inhibited even when the light guiding plate and the housing thermally expand by heat from the light source and thermally contract by turning off the light source. So, cushioning is exercised between the light guiding plate and the housing. Since the sheet is transparent, this does not adversely affect the optical characteristics of the lighting unit.

A liquid crystal display device according to the present invention comprises a lighting unit according to claim 1 or 4, and a liquid crystal display panel configured to display an image by variation of transmissivity of light according to an input image signal, wherein the liquid crystal display panel is disposed on a front surface of the lighting unit.

In such a configuration, the separating noise generated between the light guiding plate and the housing is inhibited even when the light guiding plate and the housing thermally expand by heat generated from the light source and thermally contract by turning off the light source, and the liquid crystal display device using a quiet lighting unit can be obtained.

The object, as well as other objects, features and advantages of the present invention will become more apparent from the following detailed description of the preferred embodiments taken with reference to the accompanying drawings.

### BRIEF DESCRIPTION OF THE DRAWINGS

FIG. 1 is a cross-sectional view schematically showing a structure of a liquid crystal display device according to a first embodiment of the present invention;

FIG. 2 is a cross-sectional view schematically showing a structure of a liquid crystal display device according to a second embodiment of the present invention;

FIG. 3 is a cross-sectional view schematically showing a structure of a liquid crystal display device according to a third embodiment of the present invention;

FIG. 4 is a cross-sectional view schematically showing alternative structure of the liquid crystal display device according to the third embodiment of the present invention;

FIG. 5 is a cross-sectional view schematically showing a structure of a liquid crystal display device according to a forth embodiment of the present invention;

FIG. 6 is a cross-sectional view schematically showing alternative structure of the liquid crystal display device according to the forth embodiment of the present invention; and

FIG. 7 is a cross-sectional view showing a structure of a liquid crystal display device using a lighting unit of a conventional edge light type.

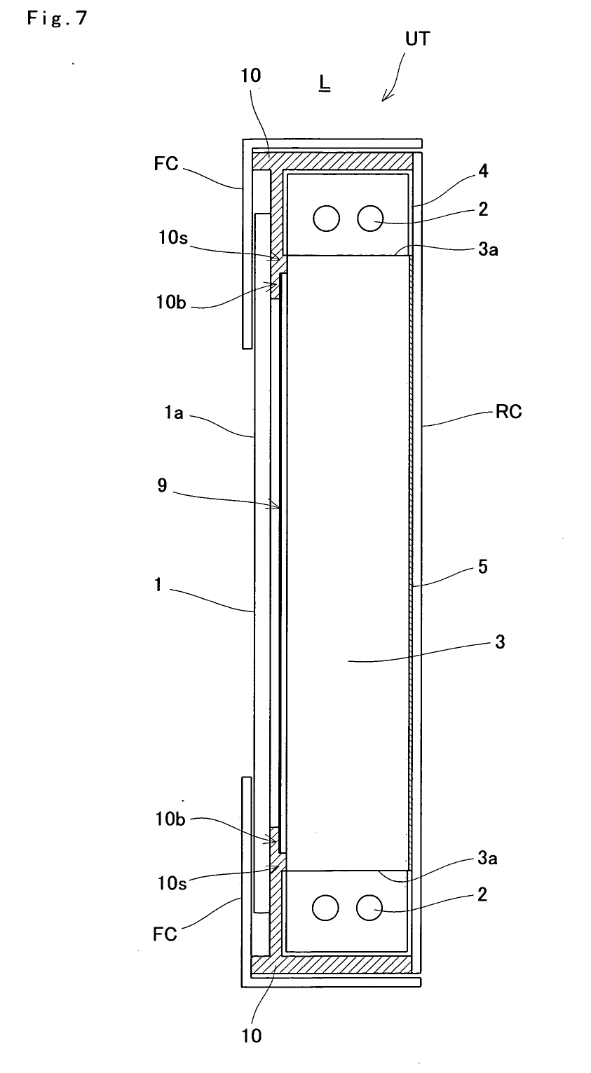

### BEST MODE FOR CARRYING OUT THE INVENTION

Hereinafter, embodiments of the present invention will be described with reference to the drawings.

### First Embodiment

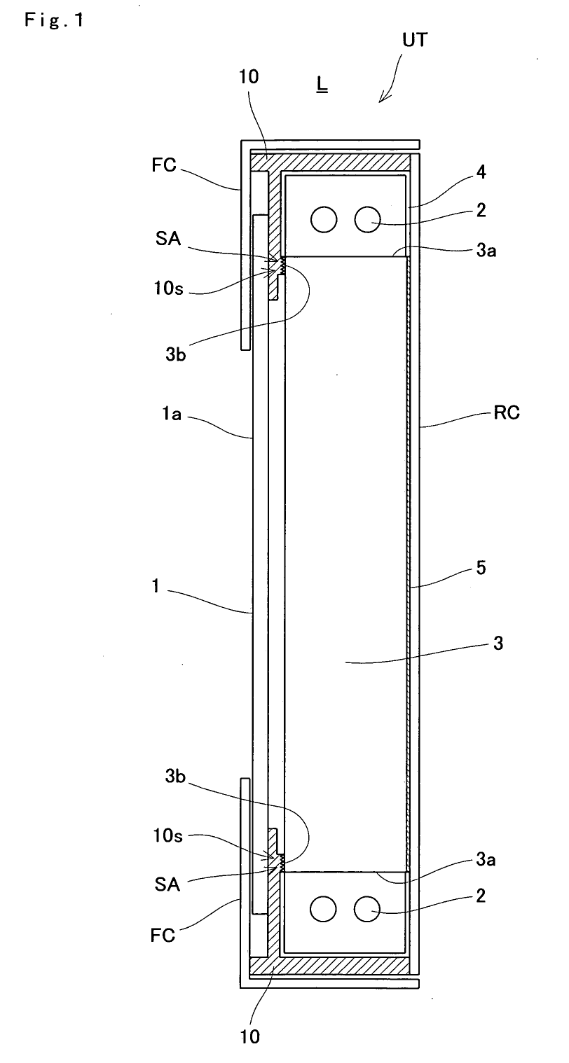

As shown in FIG. 1, a lighting unit UT according to the present embodiment comprises light sources 2, a flat light guiding plate 3 for transmitting light from the light sources 2, reflectors 4 disposed to enclose the light sources 2 to reflect the light toward the light guiding plate 3, and housings 10 disposed to enclose the reflectors 4. The light source 2 is a fluorescent discharge tube driven by a high-frequency alternating current (40 to 100 kHz) to emit light. Although two light sources 2 are disposed on one side surface of the light guiding plate 3, one light source 2 may be disposed on one side surface thereof, one or a plurality of light source 2 may be disposed on both right and left side surfaces thereof, and one light source 2 may be disposed along two sides of four sides of the side surface thereof so as to form an L-shape (called as an “L-shaped fluorescent discharge tube”), each of which is called as an edge light type.

The light guiding plate 3 is made of a material having optimal optical characteristics, such as transmissivity and a refractive index required for transmitting light, for example, acrylic. The light guiding plate 3 is provided with a dot pattern or a groove pattern (not shown) on a rear surface thereof, which varies a shape thereof according to a distance from the light source 2.

The reflector 4 is configured to reflect the light from the fluorescent discharge tube and to allow the light to efficiently enter an incident side surface 3a of the light guiding plate 3, and formed by a white resinous film or a metal film made of silver or aluminum or the like, having a high reflectivity. The reflector 4 is folded in U-shape in cross-section so as to enclose the fluorescent discharge tube 2.

The reflecting sheet 5 serves to return the light emanating from the rear surface of the light guiding plate 3 to the same again, thereby increasing an illumination light emanating therefrom, and is disposed along the rear surface of the light guiding plate 3. The reflecting sheet 5 is formed by a white resinous film having a high reflectivity. The reflector 4 may be integral with the reflecting sheet 5 by folding one side of the reflecting sheet 5 in U-shape so as to enclose the light source 2.

The housing 10 is disposed in the vicinity of the reflector 4 so as to enclose side and upper surfaces thereof. The housing 10 serves to hold a liquid crystal display panel 1, the light source 2, and the light guiding plate 3 as well as the reflector. The housing 10 is made of polycarbonate resin, for example.

A contact holding portion 10s of the housing 10 has a processed surface SA formed by a process such as texturing for increasing roughness degree of the surface (a surface contacting the light guiding plate 3) thereof. A portion having the processed surface SA with increased roughness degree may be formed on a portion 3b of the light guiding plate 3 corresponding to the contact holding portion 10s, or on both of the contact holding portion 10s and the portion 3b corresponding to the same. By applying texturing or the like to these portions for increasing roughness degree of the surface, occurrence of a disagreeable crack is inhibited. Therefore, in a liquid crystal display device L according to the present embodiment, although the light guiding plate 3 and the housing 10 thermally expand by heat generated from the light source 2 and thermally contract when the light source 2 is turned off, a separating noise generated between the light guiding plate 3 and the housing 10 is inhibited, and the light guiding plate 3 and the housing 10 contact each other by cushioning.

By attaching a rear cover RC which serves as a casing and a front side flame FC made of metal to the lighting unit UT, and by mounting a liquid crystal display panel 1 thereon after assembling the light guiding plate 3, the reflecting sheet 5 and the light source 2, the liquid crystal display device L is formed. The liquid crystal display panel 1 is configured to display characters and images, and comprises the liquid crystal display panel 1 structured such that a pair of transparent substrates provided with display electrodes are disposed to be opposed to each other with an appropriate spacing, a liquid crystal material is filled in the spacing with peripheries of the transparent substrates sealed by a sealing material, a plurality of driving circuits (not shown) disposed around the liquid crystal display panel 1 and configured to allow the liquid crystal display panel 1 to display, and a substrate (not shown) on which the driving circuits are mounted.

In the liquid crystal display device L structured such that the liquid crystal display panel 1 is mounted on the lighting unit UT, the light emitted from the light source 2 is guided to the light guiding plate 3 directly or by being collected by means of the reflector 4, and uniformly transmitted to an entire rear surface of the liquid crystal display panel 1, so that characters and images reflected in a display surface la of the liquid crystal display panel 1 are visually recognized.

A surface roughening process is not limited to the texturing, but a sandpaper process, a sandblasting process, an etching process, a plating process, a plasma process, and the like may be employed.

### Second Embodiment

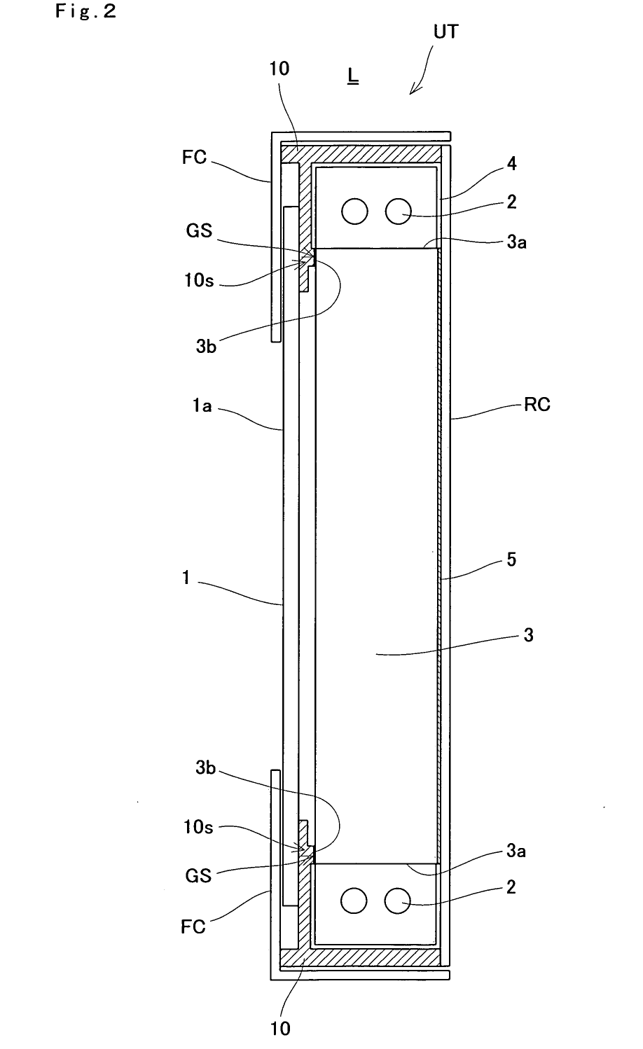

In the present embodiment, as shown in FIG. 2, lubricating grease GS is applied to the contact holding portions 10s of the housings 10 and to the portions 3b of the light guiding plate 3 corresponding to the contact holding portions 10s of the housings 10. The lubricating grease GS may be applied to either or both of the contact holding portions 10s and the portions 3b corresponding to the same. By merely applying the lubricating grease GS to these portions, occurrence of disagreeable crack can be inhibited. According to the present embodiment, since adhesion of the contact holding portion 10s of the housing 10 to the light guiding plate 3 is inhibited, the separating noise generated therebetween can be inhibited.

### Third Embodiment

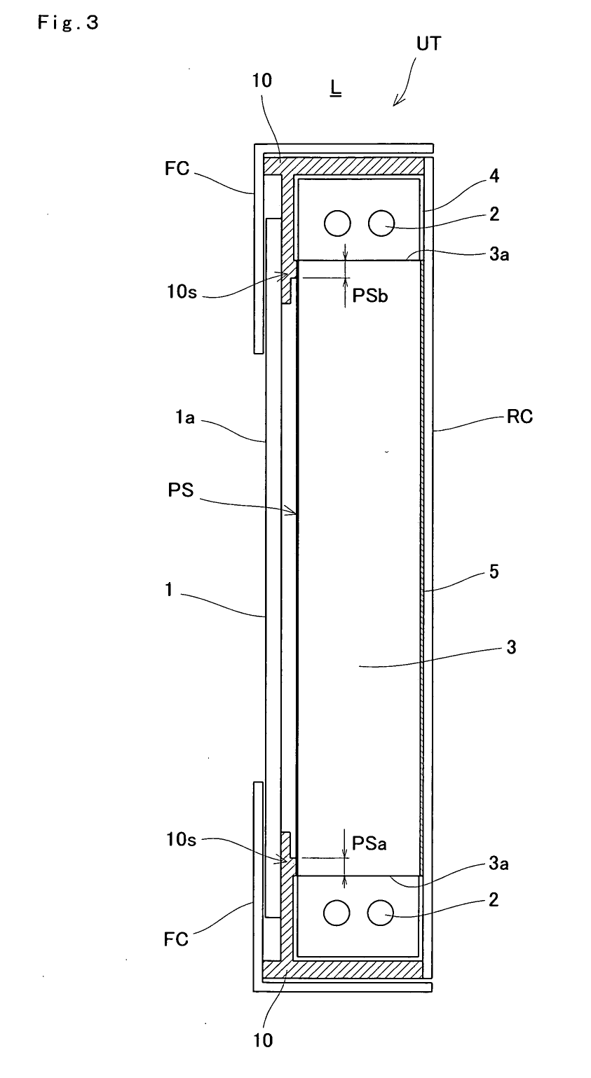

In the present embodiment, as shown in FIG. 3, a transparent sheet PS is superposed on an upper surface of the light guiding plate 3, and both right and left end portions PSb and PSa of the transparent sheet PS are interposed between the contact holding portions 10s and the light guiding plate 3. The transparent sheet PS is disposed to inhibit a separating noise generated between the housing 10 and the light guiding plate 3, and may be made of a material which does not adversely affect optical characteristics thereof, for example, polycarbonate resin or the like, synthetic resin such as a transparent acrylic plate, and the like. The transparent sheet PS may be formed by the light correction sheet 9 for uniformizing the light emanating from the light guiding plate 3 and entering the liquid crystal display device L. In this case, occurrence of the separating noise can be inhibited by using the conventional components.

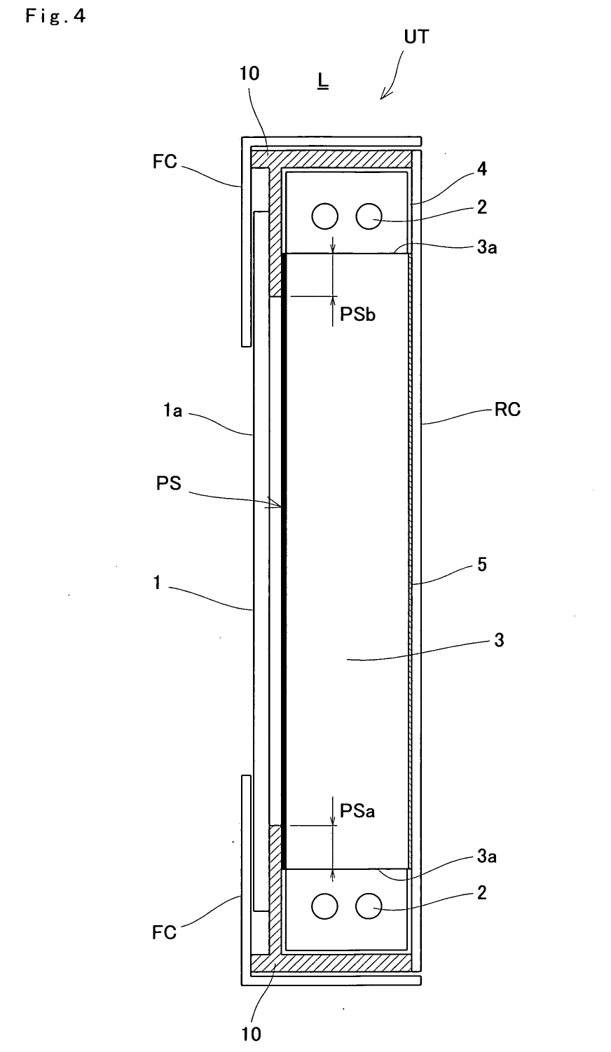

Herein, as shown in FIG. 4, the both right and left end portions PSb and PSa of the transparent sheet PS may be superposed on the housing 10 on which the contact holding portion 10s is not provided, that is to say, an upper surface of the housing 10 may directly contact an upper surface of the light guiding plate 3. Thus, a thin liquid crystal display device L can be obtained.

### Fourth Embodiment

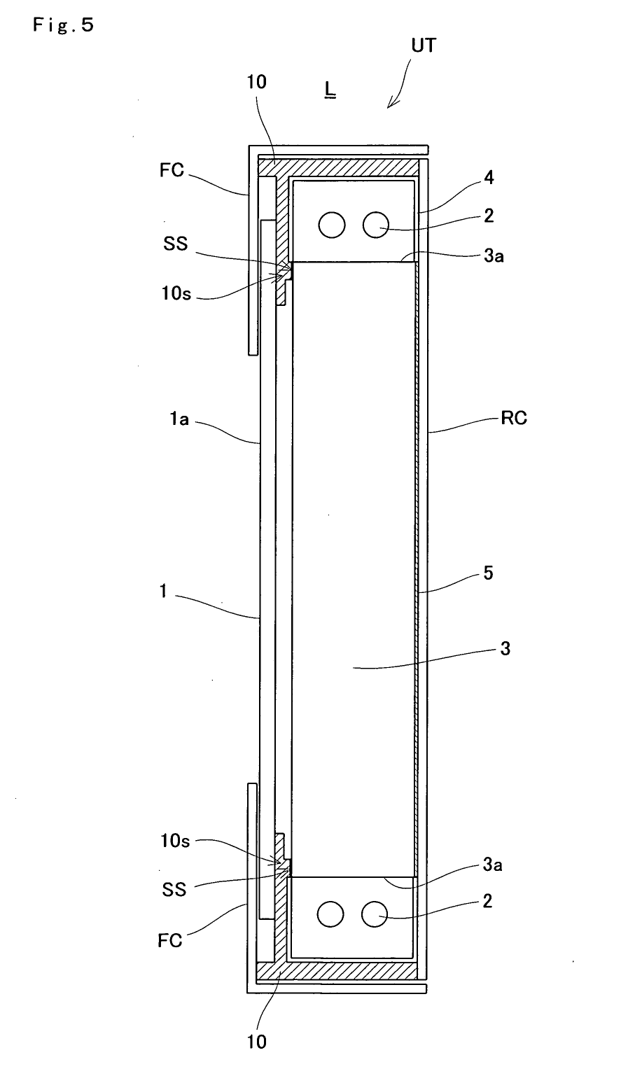

In the present embodiment, as shown in FIG. 5, sliding members SS having a sliding characteristic are interposed between the contact holding portions 10s of the housings 10 and the light guiding plate 3. The sliding member SS having the sliding characteristic is a small piece disposed in order to inhibit the separating noise generated between the contact holding portions 10s of the housing 10 and the light guiding plate 3. Since the sliding members SS having the sliding characteristic as a small piece are disposed only both right and left end portions of a front surface (above in the drawing) of the light guiding plate 3, a wide variety of members having the sliding characteristic may be used without considering its optical characteristics. For example, this may be made of polycarbonate resin or the like, synthetic resin such as a transparent acrylic plate, polyacetal, fluorine-based material, and the like. And, the light correction sheet 9 for uniformizing the light emanating from the light guiding plate 3 and entering the liquid crystal display device L may be used. According to the present embodiment, since adhesion of the contact holding portion 10s of the housing 10 to the light guiding plate 3 is inhibited, the separating noise therebetween does not occur.

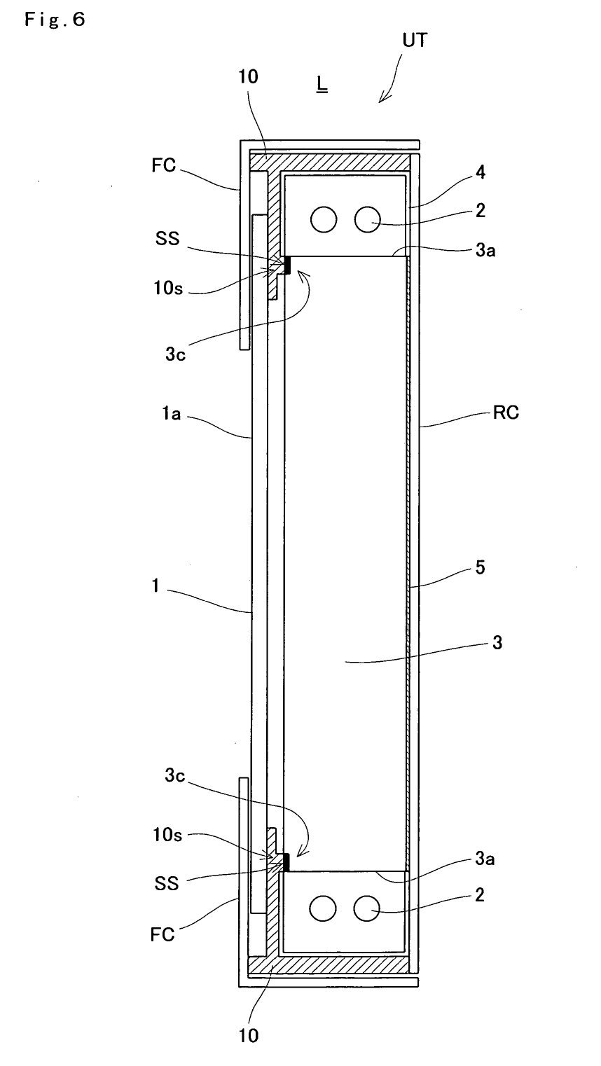

Herein, as shown in FIG. 6, concave portions 3c for fixing the sliding members SS having the sliding characteristic on the light guiding plate 3 may be provided on the light guiding plate 3. By thus providing the concave portion 3c on the light guiding plate 3, displacement of the sliding member SS having the sliding characteristic is inhibited, thereby improving assembling efficiency thereof, and a thin liquid crystal display device L can be obtained.

Although a case where two straight light sources 2 are used is described in these embodiments, one straight light source may also be used instead of the two straight light sources 2. And, although a case where the light sources 2 are disposed on both sides of the light guiding plate 3 is described, the present invention may be generally applied to edge light types in which a power supply is disposed on one side of the light guiding plate 3, and a light source is disposed in L-shape.

The lighting unit and the liquid crystal display device using the same according to the present invention are structured such that at least either of the contact holding portion of the housing and the portion of the light guiding plate corresponding to the contact holding portion of the housing has the surface with increased roughness degree formed by texturing or the like, the lubricating grease is applied to at least either of these portions, and the transparent sheet and the sliding member having the sliding characteristic are interposed therebetween. So, even when the light guiding plate and the housing thermally expand by heat generated from the light source and thermally contract when the light source is turned off, a separating noise generated therebetween is inhibited, and it becomes possible to keep a quiet state during and after use of the light guiding plate.

Although in the above-described first to fourth embodiments, the liquid crystal display panel and the liquid crystal display device are described as examples of the image display element and the image display device, respectively, other components may also be used.

Numerous modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the sprit of the invention.

### INDUSTRIAL APPLICABILITY

A lighting unit according to the present invention is useful as a lighting unit of a consumer and industrial liquid crystal display device in which a thin display portion is required.

A liquid crystal display device according to the present invention is useful as an image display device of an information device such as a consumer and industrial notebook-type personal computer and word processor or the like, or of a portable television, a video movie, a car navigation system, and the like.

1. A lighting unit comprising:
a light guiding plate for guiding light entering from an end face thereof along a principal surface thereof;
a light source disposed along the end face of the light guiding plate;
a reflector configured to enclose the light source to reflect the light emitted from the light source toward the end face of the light guiding plate; and
a housing disposed to enclose at least the reflector and configured to hold the light guiding plate; wherein
at least one contact surface of a predetermined region at which the housing and the light guiding plate contact each other is roughened.

2. The lighting unit according to claim 1, wherein lubricant is applied to the predetermined region at which the housing and the light guiding plate are opposed to each other.

3. The lighting unit according to claim 1, wherein a sliding member is disposed on the predetermined region at which the housing and the light guiding plate are opposed to each other.

4. A lighting unit comprising:
a light guiding plate for guiding light entering from an end face thereof along a principal surface thereof;
a light source disposed along the end face of the light guiding plate;
a reflector configured to enclose the light source to reflect the light emitted from the light source toward the end face of the light guiding plate; and
a housing disposed to enclose at least the reflector and configured to hold the light guiding plate; wherein
a transparent sheet is disposed on the principal surface of the light guiding plate, and the transparent sheet is disposed on a predetermined region at which the housing and the light guiding plate are opposed to each other.

5. A liquid crystal display device comprising:
a lighting unit according to claim 1 or 4; and
a liquid crystal display panel configured to display an image by variation of transmissivity of light according to an input image signal; wherein
the liquid crystal display panel is disposed on a front surface of the lighting unit.
